(19) United States
(12) Patent Application Publication
(10) Pub. No.: US 2005/0172072 A1
(43) Pub. Date: Aug. 4, 2005

(54) Multiple site data replication

(76) Inventors: Robert A. Cochran, Sacramento, CA (US); John Bates, Mendon, MA (US); John Wilkes, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,275

(22) Filed: Jan. 30, 2004

(51) Int. Cl. G06F 12/16

(52) U.S. Cl. 711/114; 711/162

(57) ABSTRACT

A storage network architecture is disclosed. The network comprises a first storage site comprising a first set of disk drives, a second storage site communicatively connected to the first storage site and comprising a storage medium, and a third storage site communicatively connected to the second storage site and comprising a second set of disk drives. The second storage site provides a data write spool service to the first storage site.

### TECHNICAL FIELD

The described subject matter relates to electronic computing, and more particularly to systems and methods for managing storage in electronic computing systems.

### BACKGROUND

Effective collection, management, and control of information have become a central component of modem business processes. To this end, many businesses, both large and small, now implement computer-based information management systems.

Data management is an important component of computer-based information management systems. Many businesses now implement storage networks to manage data operations in computer-based information management systems. Storage networks have evolved in computing power and complexity to provide highly reliable, managed storage solutions that may be distributed across a wide geographic area.

Data redundancy is one aspect of reliability in storage networks. A single copy of data is vulnerable if the network element on which the data resides fails. If the vulnerable data or the network element on which it resides can be recovered, then the loss may be temporary. If neither the data nor the network element can be recovered, then the vulnerable data may be lost permanently.

Storage networks implement remote copy procedures to provide data redundancy. Remote copy procedures replicate data sets resident on a first storage site onto a second storage site, and sometimes onto a third storage site. Remote copy procedures have proven effective at enhancing the reliability of storage networks, but at a significant increase in the expense of implementing a storage network.

### SUMMARY

In an exemplary implementation a storage network is provided. The storage network comprises a first storage site comprising a first set of disk drives; a second storage site communicatively connected to the first storage site and comprising a storage medium; and a third storage site communicatively connected to the second storage site and comprising a second set of disk drives. The second storage site provides a data write spool service to the first storage site.

### BRIEF DESCRIPTION OF THE DRAWINGS

FIG. 1 is a schematic illustration of an exemplary implementation of a networked computing system that utilizes a storage network;

FIG. 2 is a schematic illustration of an exemplary implementation of a storage network;

FIG. 3 is a schematic illustration of an exemplary implementation of a computing device that can be utilized to implement a host;

FIG. 4 is a schematic illustration of an exemplary implementation of a storage cell;

FIG. 5 is a schematic illustration of an exemplary implementation of components and connections that implement a multiple site data replication architecture in a storage network; and

FIG. 6 is a flowchart illustrating exemplary operations implemented by a network element in a storage site.

### DETAILED DESCRIPTION

Described herein are exemplary storage network architectures and methods for implementing multiple site data replication. The methods described herein may be embodied as logic instructions on a computer-readable medium. When executed on a processor, the logic instructions cause a general purpose computing device to be programmed as a special-purpose machine that implements the described methods.

Exemplary Network Architecture

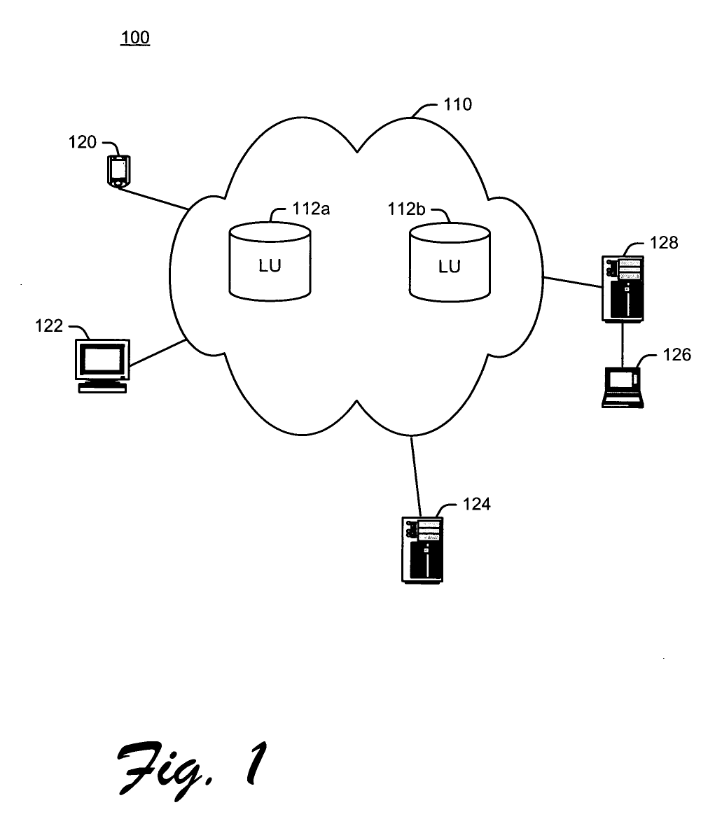

FIG. 1 is a schematic illustration of an exemplary implementation of a networked computing system 100 that utilizes a storage network. The storage network comprises a storage pool 110, which comprises an arbitrarily large quantity of storage space. In practice, a storage pool 110 has a finite size limit determined by the particular hardware used to implement the storage pool 110. However, there are few theoretical limits to the storage space available in a storage pool 110.

A plurality of logical disks (also called logical units or LUs) 112a, 112b may be allocated within storage pool 110. Each LU 112a, 112b comprises a contiguous range of logical addresses that can be addressed by host devices 120, 122, 124 and 128 by mapping requests from the connection protocol used by the host device to the uniquely identified LU 112. As used herein, the term “host” comprises a computing system(s) that utilize storage on its own behalf, or on behalf of systems coupled to the host. For example, a host may be a supercomputer processing large databases or a transaction processing server maintaining transaction records. Alternatively, a host may be a file server on a local area network (LAN) or wide area network (WAN) that provides storage services for an enterprise. A file server may comprise one or more disk controllers and/or RAID controllers configured to manage multiple disk drives. A host connects to a storage network via a communication connection such as, e.g., a Fibre Channel (FC) connection.

A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which are also hosts, may logically couple directly to LUs 112a, 112b. Hosts 120-128 may couple to multiple LUs 112a, 112b, and LUs 112a, 112b may be shared among multiple hosts. Each of the devices shown in FIG. 1 may include memory, mass storage, and a degree of data processing capability sufficient to manage a network connection.

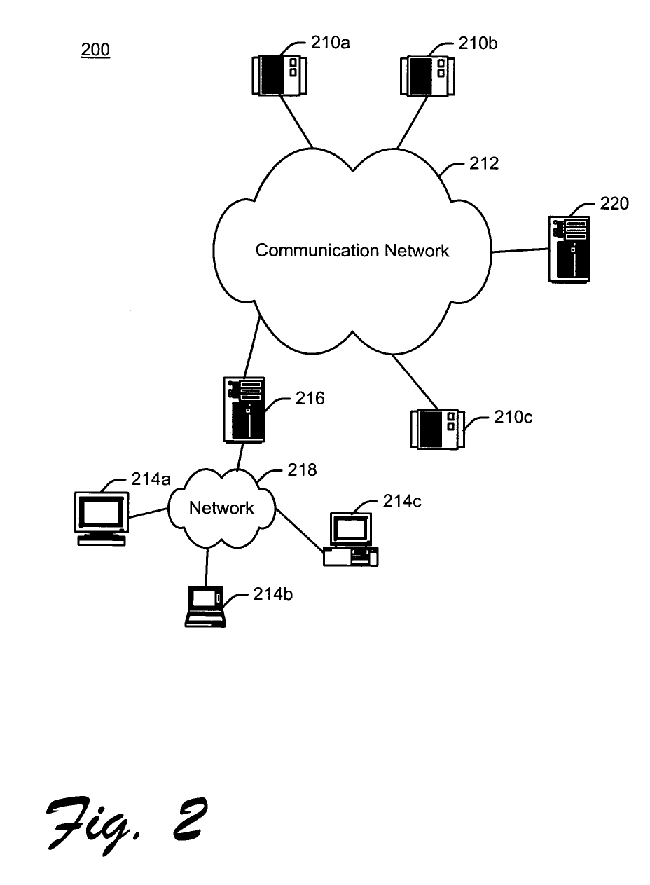

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available form Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (iSCSI) protocol.

Client computers 214a, 214b, 214c may access storage cells 210a, 210b, 210c through a host, such as servers 216, 220. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. A switching fabric comprising a single FC switch can interconnect 256 or more ports, providing a possibility of hundreds of storage cells 210a, 210b, 210c in a single storage network.

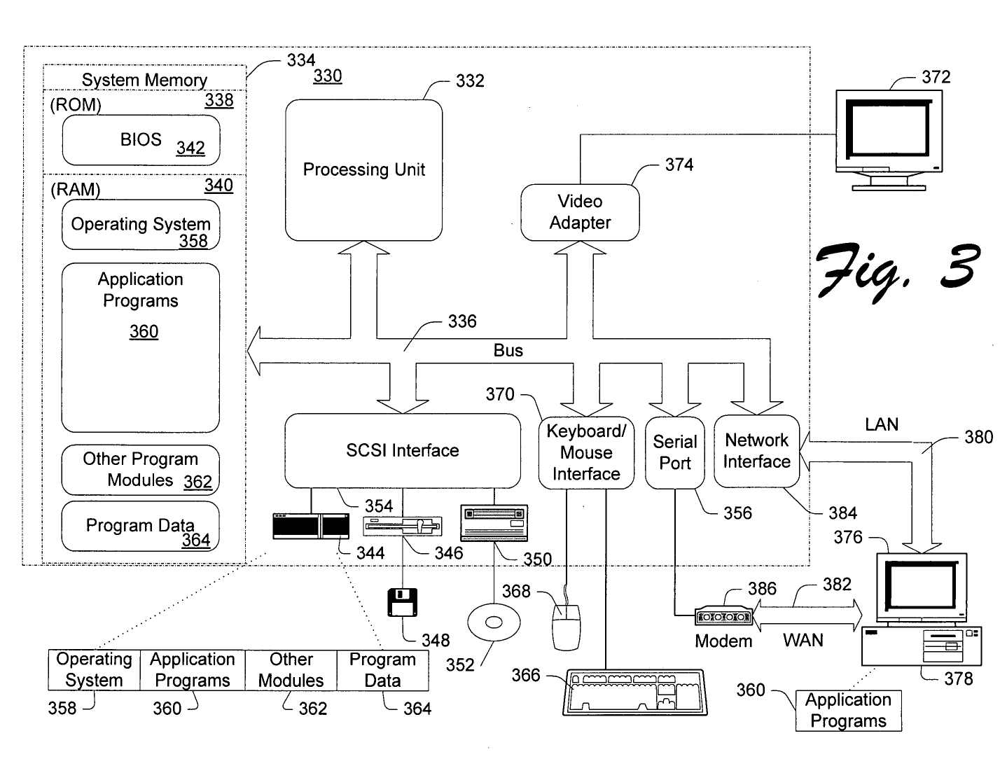

Hosts 216, 220 are typically implemented as server computers. FIG. 3 is a schematic illustration of an exemplary computing device 330 that can be utilized to implement a host. It will be appreciated that the computing device 330 depicted in FIG. 3 is merely one exemplary embodiment, which is provided for purposes of explanation. The techniques described herein may be implemented on any computing device. The particular details of the computing device 330 are not critical. Computing device 330 includes one or more processors or processing units 332, a system memory 334, and a bus 336 that couples various system components including the system memory 334 to processors 332. The bus 336 represents one or more of any of several types of bus structures, including a memory bus or memory controller, a peripheral bus, an accelerated graphics port, and a processor or local bus using any of a variety of bus architectures. The system memory 334 includes read only memory (ROM) 338 and random access memory (RAM) 340. A basic input/output system (BIOS) 342, containing the basic routines that help to transfer information between elements within computing device 330, such as during start-up, is stored in ROM 338.

Computing device 330 further includes a hard disk drive 344 for reading from and writing to a hard disk (not shown), and may include a magnetic disk drive 346 for reading from and writing to a removable magnetic disk 348, and an optical disk drive 350 for reading from or writing to a removable optical disk 352 such as a CD ROM or other optical media. The hard disk drive 344, magnetic disk drive 346, and optical disk drive 350 are connected to the bus 336 by a SCSI interface 354 or some other appropriate interface. The drives and their associated computer-readable media provide nonvolatile storage of computer-readable instructions, data structures, program modules and other data for computing device 330. Although the exemplary environment described herein employs a hard disk, a removable magnetic disk 348 and a removable optical disk 352, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 344, magnetic disk 348, optical disk 352, ROM 338, or RAM 340, including an operating system 358, one or more application programs 360, other program modules 362, and program data 364. A user may enter commands and information into computing device 330 through input devices such as a keyboard 366 and a pointing device 368. Other input devices (not shown) may include a microphone, joystick, game pad, satellite dish, scanner, or the like. These and other input devices are connected to the processing unit 332 through an interface 370 that is coupled to the bus 336. A monitor 372 or other type of display device is also connected to the bus 336 via an interface, such as a video adapter 374.

Computing device 330 may operate in a networked environment using logical connections to one or more remote computers, such as a remote computer 376. The remote computer 376 may be a personal computer, a server, a router, a network PC, a peer device or other common network node, and typically includes many or all of the elements described above relative to computing device 330, although only a memory storage device 378 has been illustrated in FIG. 3. The logical connections depicted in FIG. 3 include a LAN 380 and a WAN 382.

When used in a LAN networking environment, computing device 330 is connected to the local network 380 through a network interface or adapter 384. When used in a WAN networking environment, computing device 330 typically includes a modem 386 or other means for establishing communications over the wide area network 382, such as the Internet. The modem 386, which may be internal or external, is connected to the bus 336 via a serial port interface 356. In a networked environment, program modules depicted relative to the computing device 330, or portions thereof, may be stored in the remote memory storage device. It will be appreciated that the network connections shown are exemplary and other means of establishing a communications link between the computers may be used.

Hosts 216, 220 may include host adapter hardware and software to enable a connection to communication network 212. The connection to communication network 212 may be through an optical coupling or more conventional conductive cabling depending on the bandwidth requirements. A host adapter may be implemented as a plug-in card on computing device 330. Hosts 216, 220 may implement any number of host adapters to provide as many connections to communication network 212 as the hardware and software support.

Generally, the data processors of computing device 330 are programmed by means of instructions stored at different times in the various computer-readable storage media of the computer. Programs and operating systems may distributed, for example, on floppy disks, CD-ROMs, or electronically, and are installed or loaded into the secondary memory of a computer. At execution, the programs are loaded at least partially into the computer's primary electronic memory.

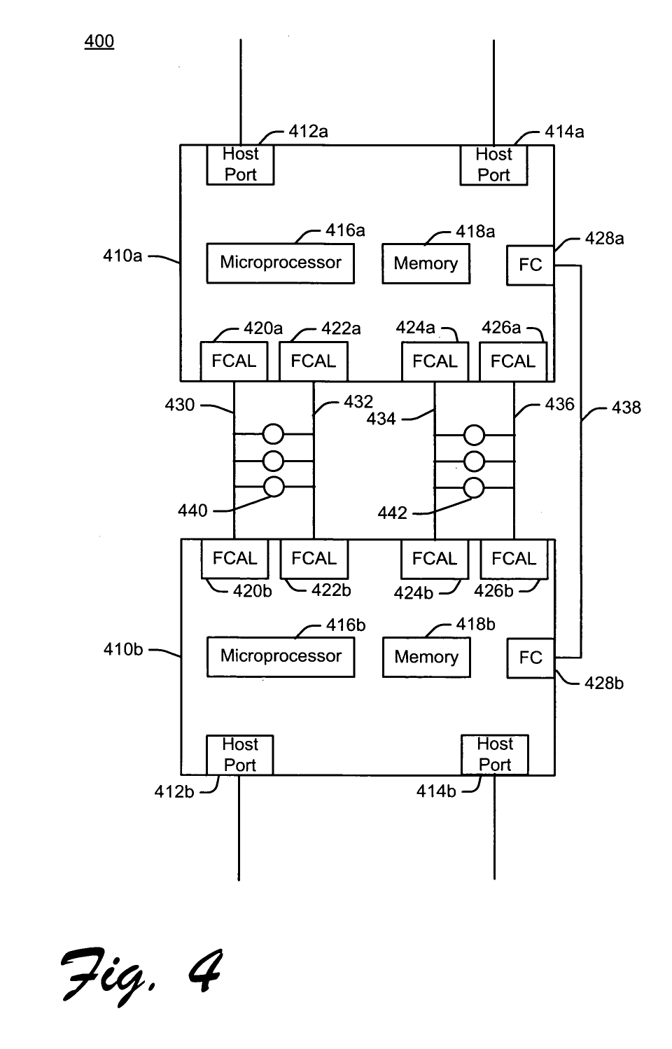

FIG. 4 is a schematic illustration of an exemplary implementation of a storage cell 400. It will be appreciated that the storage cell 400 depicted in FIG. 4 is merely one exemplary embodiment, which is provided for purposes of explanation. The particular details of the storage cell 400 are not critical. Referring to FIG. 4, storage cell 400 includes two Network Storage Controllers (NSCs), also referred to as disk controllers, 410a, 410b to manage the operations and the transfer of data to and from one or more sets of disk drives 440, 442. NSCs 410a, 410b may be implemented as plug-in cards having a microprocessor 416a, 416b, and memory 418a, 418b. Each NSC 410a, 410b includes dual host adapter ports 412a, 414a, 412b, 414b that provide an interface to a host, i.e., through a communication network such as a switching fabric. In a Fibre Channel implementation, host adapter ports 412a, 412b, 414a, 414b may be implemented as FC N_Ports. Each host adapter port 412a, 412b, 414a, 414b manages the login and interface with a switching fabric, and is assigned a fabric-unique port ID in the login process. The architecture illustrated in FIG. 4 provides a fully-redundant storage cell. This redundancy is entirely optional; only a single NSC is required to implement a storage cell.

Each NSC 410a, 410b further includes a communication port 428a, 428b that enables a communication connection 438 between the NSCs 410a, 410b. The communication connection 438 may be implemented as a FC point-to-point connection, or pursuant to any other suitable communication protocol.

In an exemplary implementation, NSCs 410a, 410b further include a plurality of Fiber Channel Arbitrated Loop (FCAL) ports 420a-426a, 420b-426b that implements an FCAL communication connection with a plurality of storage devices, e.g., sets of disk drives 440, 442. While the illustrated embodiment implement FCAL connections with the sets of disk drives 440, 442, it will be understood that the communication connection with sets of disk drives 440, 442 may be implemented using other communication protocols. For example, rather than an FCAL configuration, a FC switching fabric may be used.

In operation, the storage capacity provided by the sets of disk drives 440, 442 may be added to the storage pool 110. When an application requires storage capacity, logic instructions on a host computer 128 establish a LU from storage capacity available on the sets of disk drives 440, 442 available in one or more storage sites. It will be appreciated that, because a LU is a logical unit, not a physical unit, the physical storage space that constitutes the LU may be distributed across multiple storage cells. Data for the application is stored on one or more LUs in the storage network. An application that needs to access the data queries a host computer, which retrieves the data from the LU and forwards the data to the application.

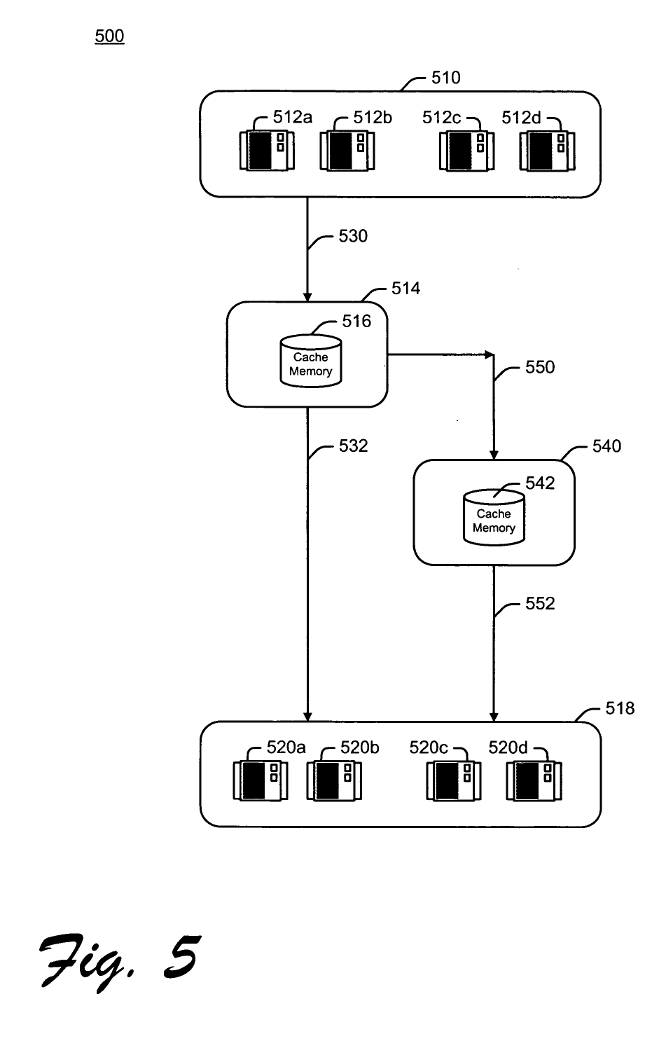

FIG. 5 is a schematic illustration of an exemplary implementation of components and connections of a multiple site data replication architecture 500 in a storage network. The components and connections illustrated in FIG. 5 may be implemented in a storage network of the type illustrated in FIG. 2. Referring to FIG. 5 there is illustrated a first storage site 510 comprising one or more disk arrays 512a-512d, a second storage site 514 comprising a cache memory 516, and a third storage site 518 comprising one or more disk arrays 520a-520d. Also shown is an optional fourth storage site 540 comprising a cache memory 542. Optional storage site 540 is adjunct to the second storage site 514. The storage sites 510, 514, 518, and 540 may be implemented by one or more storage cells as described above. As such, each storage site 510, 514, 518, and 540 may include a plurality of disk arrays.

A first communication connection 530 is provided between the first storage site 510 and the second storage site 514, and a second communication connection 532 is provided between the second storage site 514 and third storage site 518. Assuming the optional storage site 540 is implemented, a third communication connection 550 is provided between the second storage site 514 and the optional storage site 540, and a fourth communication connection 552 is provided between the optional storage site 540 and the third storage site 518. In an exemplary implementation the communication connections 530, 532, 550, 552 may be provided by a switching fabric such as a FC fabric, or a switching fabric that operates pursuant to another suitable communication protocol, e.g., SCSI, iSCSI, LAN, WAN, etc.

In an exemplary implementation, the first storage site 510 may be separated from the second storage site 514 by a distance of up to 40-100 kilometers, while the second storage site may be separated from the third storage site 518 by a much greater distance, e.g., between 400 and 5000 kilometers. The optional storage site 540 may be co-located with the second storage site 514, or may be separated from the second storage site 514 by a distance of up to 100 kilometers. The particular distance between any of the storage sites is not critical.

In one exemplary implementation, second storage site 514 includes a network element that has communication, processing, and storage capabilities. The network element includes an input port configured to receive data from a first storage site in the storage network, a cache memory module configured to store the received data, and a processor configured to aggregate data stored in the cache memory and to transmit the data to a third storage site. In one exemplary implementation the network element may be embodied as a plug-in card like the NSC card described in connection with FIG. 4. Host ports 412a, 412b, 414a, 414b may function as an input port. Microprocessors 416a, 416b may function as the processor. The cache memory 516 in the second storage site 514 and the cache memory 542 in optional storage site 540 may be implemented in the memory module 418a and/or the disk arrays 442, 444. Alternatively, the cache memory 516 may be implemented in RAM cache, or on any other suitable storage medium, e.g., an optical or other magnetic storage medium.

In an alternate implementation, the network element may be embodied as a stand-alone storage appliance. In an alternate implementation, the cache memory 516 in the second storage site 514 and the cache memory 542 in optional storage site 540 may be implemented using a low-cost replication appliance such as, e.g., the SV-3000 model disk array commercially available from Hewlett Packard Corporation of Palo Alto, Calif., USA.

Exemplary Operations

In an exemplary implementation, the components and connections depicted in FIG. 5 may be used to implement a three-site data replication architecture. For purposes of explanation, it will be assumed that the data being replicated is hosted on the first storage site 510. In the architecture of FIG. 5, full copies of data hosted on first storage site 510 reside only at the first storage site 510 and the third storage site 518. The second storage site 514 need not implement a full copy of the data on the first storage site 510 being replicated. Instead, the second storage site 514 provides an in-order write spool service to the first storage site 510. Data written to the first storage site 510 is spooled on the second storage site 514, and written to the third storage site. In one exemplary implementation, data writes from the first storage site to the second storage site may be synchronous, while data writes from the second storage site to the third storage site may be asynchronous. However, write operations may be implemented as either synchronous or asynchronous.

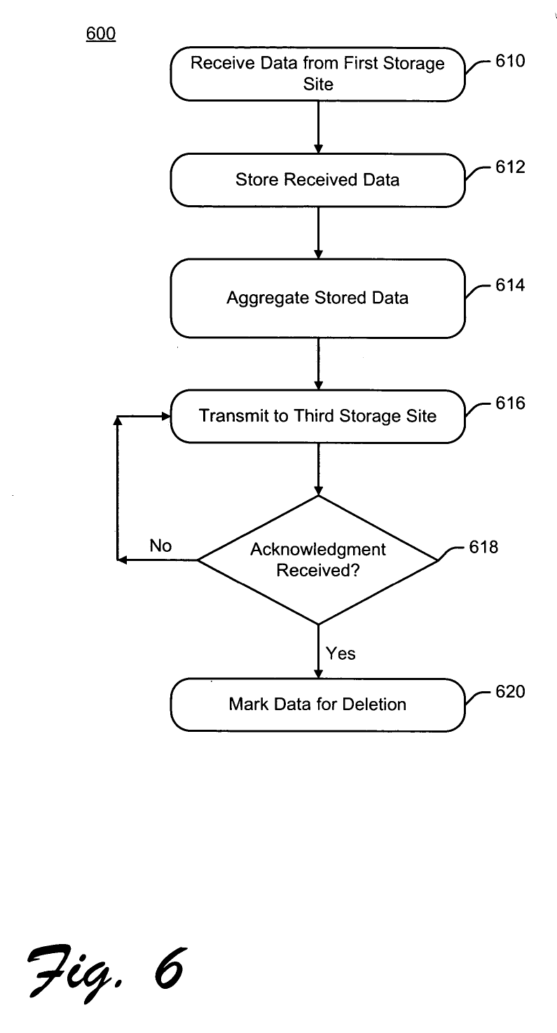

FIG. 6 is a flowchart illustrating exemplary operations 600 implemented by the network element in second storage site 514. When data is written to the first storage site 510, the first storage site writes the data to the second storage site 514. The write operation may be synchronous or asynchronous. At operation 610 the second storage site 514 receives data from the first storage site 510, and at operation 612 the received data is stored in the cache memory of a suitable storage medium.

At operation 614 data in the cache memory of the second storage site 514 is aggregated into write blocks of a desired size for transmission to the third storage site. Conceptually, the aggregation routine may be considered as having a producer component that writes data into the cache memory of the second storage site and a consumer component that retrieves data from the cache memory and forwards it to the third storage site. The write operations may be synchronous or asynchronous. The size of inbound and outbound write blocks may differ, and the size of any given write block may be selected as a function of the configuration of the network equipment and/or the transmission protocol in the communication link(s) between the second storage site 514 and the third storage site 518. In Fibre Channel implementations, the write block size may be selected as a multiple of 64 KB.

In an exemplary implementation the write spool implements a first-in, first-out (FIFO) queue, in which data is written from the queue in the order in which it was received. In an alternate implementation data received from the first storage site 510 includes an indicator that identifies a logical group (e.g., a LU or a data consistency group) with which the data is associated and a sequence number indicating the position of the write operation in the logical group. In this embodiment the aggregation routine may implement a modified FIFO queue that selects data associated with the same logical group for inclusion in the write block.

At operation 616 the write block is transmitted to the third storage site 518. At operation 618 the network element waits to receive an acknowledgment signal from the third storage site 518 indicating that the write block transmitted in operation 616 was received by the third storage site 518. When the acknowledgment signal is received, the data received by the third storage site may be marked for deletion, at operation 620. The marked data may be deleted from the write spool, or may be marked with an indicator that allows the memory space in which the data resides to be overwritten.

In an alternate implementation in a network architecture having an optional fourth storage site 540, the network element in the second storage site 514 implements a synchronous write of data received in operation 610 to the optional fourth storage site 540. The network element in storage site 540 provides a synchronous write spool service to the network element in storage site 514. However, in normal operation the network element in storage site 540 does not need to transmit its data to the third storage site 518. Rather, the network element in storage site 540 transmits its data to the third storage site only upon failure in operation of the second storage site 514.

The network architecture depicted in FIG. 5 implementing the operations 600 depicted in FIG. 6 provides a fully-redundant, asynchronous replication of data stored in the first storage site 510 onto the third storage site at a lower cost than an architecture that requires a complete disk array at the second storage site 514.

In addition to the specific embodiments explicitly set forth herein, other aspects and embodiments of the present invention will be apparent to those skilled in the art from consideration of the specification disclosed herein. It is intended that the specification and illustrated embodiments be considered as examples only, with a true scope and spirit of the invention being indicated by the following claims.

1. A storage network, comprising:
a first storage site comprising a first set of disk drives;
a second storage site communicatively connected to the first storage site and comprising a storage medium; and
a third storage site communicatively connected to the second storage site and comprising a second set of disk drives,
wherein the second storage site provides a data write spool service to the first storage site.

2. The storage network of claim 1, wherein write operations on the first storage site are synchronously replicated in the storage medium in the second storage site

3. The storage network of claim 1, wherein the second storage site comprises:
a cache memory implemented in the storage medium; and
a network element comprising a processor configured to aggregate data stored in the cache memory and to transmit the data to a third storage site.

4. The storage network of claim 1, wherein the storage medium on the second storage site comprises at least one RAID group.

5. The storage network of claim 1, further comprising a fourth storage site communicatively connected to the second storage site and the third storage site and comprising a storage medium, wherein the fourth storage site provides a data write spool service to the second storage site.

6. The storage network of claim 5, wherein write operations on the second storage site are synchronously replicated in the storage medium in the fourth storage site.

7. A method, comprising:
receiving, at a second storage site, data from one or more write operations executed on a first storage site;
storing the received data in a write spool queue; and
transmitting the received data to a third storage site.

8. The method of claim 7, further comprising aggregating received data into block sizes of a predetermined size before forwarding the data to a third storage site.

9. The method of claim 7, wherein the received data comprises a first identifier that indicates a logical group with which the data is associated and a sequence number within the logical group.

10. The method of claim 9, further comprising aggregating data associated with the same logical group.

11. The method of claim 7, further comprising marking for deletion from the write spool data transmitted to the third storage site.

12. The method of claim 7, further comprising receiving, from the third storage site, an acknowledgement signal identifying data transmitted from the second storage site has been received at the third storage site.

13. The method of claim 12, further comprising marking for deletion data for which an acknowledgment signal has been received.

14. The method of claim 7, further comprising transmitting received data to a fourth storage site.

15. A network element in a storage network, comprising:
an input port configured to receive data from a first storage site in the storage network;
a cache memory module configured to store the received data; and
a processor configured to aggregate data stored in the cache memory and to transmit the data to a third storage site.

16. The network element of claim 15, wherein the cache memory module comprises a disk-based cache memory.

17. The network element of claim 15, wherein the cache memory module comprises a RAM-based cache memory.

18. The network element of claim 15, wherein the processor is further configured to mark for deletion from the write spool data transmitted to the third storage site.

19. One or more computer-readable media having computer-readable instructions thereon which, when executed by a processor, configure the processor to:
receive data from one or more write operations executed on a first remote storage site;
store the received data in a write spool queue; and
transmit the received data to a second remote storage site.

20. The computer readable media of claim 19, wherein the instructions further configure the processor to aggregate received data into block sizes of a predetermined size before forwarding the data to a third storage site.

21. The computer readable media of claim 19, wherein the received data comprises a first identifier that indicates a logical group with which the data is associated and a sequence number within the logical group.

22. The computer readable media of claim 21, wherein the instructions further configure the processor to aggregate data associated with the same logical group.

23. The computer readable media of claim 19, wherein the instructions further configure the processor to mark for deletion from the write spool data transmitted to the third storage site.

24. The computer readable media of claim 19, wherein the instructions further configure the processor to receive, from the third storage site, an acknowledgement signal identifying data transmitted from the second storage site has been received at the third storage site.

25. The computer readable media of claim 24, wherein the instructions further configure the processor to mark for deletion data for which an acknowledgment signal has been received.

26. The computer readable media of claim 19, wherein the instructions further configure the processor to synchronously transmit received data to a fourth storage site.
